(19) United States
(12) Patent Application Publication
(10) Pub. No.: US 2024/0123956 A1
(43) Pub. Date: Apr. 18, 2024

(54) BRAKE SYSTEM FOR SADDLED VEHICLE

(71) Applicant: Honda Motor Co., Ltd., Tokyo (JP)

(72) Inventors: Hiroyuki KANETA, Minato-ku, Tokyo (JP); Tsubasa NOSE, Minato-ku, Tokyo (JP); Kyosuke INADA, Minato-ku, Tokyo (JP); Yuta KANBE, Wako-shi, Saitama (JP)

(73) Assignee: Honda Motor Co., Ltd., Tokyo (JP)

(21) Appl. No.: 18/277,704

(22) PCT Filed: Dec. 17, 2021
(86) PCT No.: PCT/JP2021/046861

§ 371 Date: Aug. 17, 2023

(30) Foreign Application Priority Data
Mar. 4, 2021 (JP) 2021-034321

(51) Int. Cl. B60T 8/26; B60T 8/32

(52) U.S. Cl. CPC B60T 8/261; B60T 8/3225

(57) ABSTRACT

To provide a brake system for a saddled vehicle that suppresses the speed at which the vehicle transitions to a front-dropping posture, thereby enhancing the driver's sense of security. A brake system for a saddled vehicle includes a control device exerting automatic control over a brake fluid pressure of a brake according to various information, and a pitch angular velocity detector for detecting a pitch angular velocity of the vehicle according to an output of a pitch angular velocity detection unit. When the pitch angular velocity becomes equal to or greater than a predetermined threshold value while the control device is gradually increasing the brake fluid pressure of the front-wheel brake by the automatic control, the control device reduces a degree of increase in the brake fluid pressure or maintains the brake fluid pressure at that time point.

### FIELD

The present invention relates to a brake system for a saddled vehicle, and in particular, to a brake system for a saddled vehicle that enables automatic control according to information from various sensors.

### BACKGROUND

Conventionally, a brake system that enables automatic control according to information from various sensors is known.

Patent Literature 1 discloses a brake system that works as follows. In exerting automatic brake system control, the system applies a smaller braking force to observe changes in the driver's posture. If a major change is not observed, the system applies the target braking force.

### Citation List

### Patent Literature

Patent Literature 1: JP 2020-158076 A

### BRIEF SUMMARY

### Technical Problem

Here, when the system increases the brake fluid pressure of the front-wheel brake in order to apply the target braking force, the front-wheel suspension contracts and the vehicle body tends to drop on the front side. If the speed at which the vehicle reaches this front-dropping posture is too fast, the driver feels unsafe.

An object of the present invention is to solve the problem, and to provide a brake system for a saddled vehicle that suppresses the speed at which the vehicle transitions to a front-dropping posture, thereby enhancing the driver's sense of security.

### Solution to Problem

In order to achieve the object, a first aspect of the present invention provides a brake system for a saddled vehicle including a control device (70) exerting automatic control over a brake fluid pressure of a brake (BF, BR) according to various information; and pitch angular velocity detecting means (73) for detecting a pitch angular velocity (w) of the vehicle according to an output of a pitch angular velocity detection unit (95). When the pitch angular velocity (w) becomes equal to or greater than a predetermined threshold value while the control device (70) is gradually increasing the brake fluid pressure of a front-wheel brake (BF) by the automatic control, the control device (70) reduces a degree of increase in the brake fluid pressure or maintains the brake fluid pressure at that time point.

A second aspect of the present invention further includes a seat sensor (76) detecting a driver's seated state. The control device (70) reduces the predetermined threshold value when the seat sensor (76) does not detect the driver's seated state.

In a third aspect of the present invention, the control device (70) reduces the predetermined threshold value when the control device (70) determines that a road surface on which the vehicle is traveling is downhill, and increases the predetermined threshold value when control device (70) determines that the road surface is uphill.

### Advantageous Effects

According to the first aspect, a brake system for a saddled vehicle includes a control device (70) exerting automatic control over a brake fluid pressure of a brake (BF, BR) according to various information; and pitch angular velocity detecting means (73) for detecting a pitch angular velocity (w) of the vehicle according to an output of a pitch angular velocity detection unit (95). When the pitch angular velocity (w) becomes equal to or greater than a predetermined threshold value while the control device (70) is gradually increasing the brake fluid pressure of a front-wheel brake (BF) by the automatic control, the control device (70) reduces a degree of increase in the brake fluid pressure or maintains the brake fluid pressure at that time point. This suppresses the speed at which the vehicle transitions to a front-dropping posture, thereby enhancing the driver's sense of security.

The second aspect further includes a seat sensor (76) detecting a driver's seated state. The control device (70) reduces the predetermined threshold value when the seat sensor (76) does not detect the driver's seated state. Thus, the system reduces the predetermined threshold value so as to advance the timing of the switch to reduce the increase degree of the front-wheel brake fluid pressure or to maintain the brake fluid pressure at that time point. This enhances the driver's sense of security.

According to the third aspect, the control device (70) reduces the predetermined threshold value when the control device (70) determines that a road surface on which the vehicle is traveling is downhill, and increases the predetermined threshold value when control device (70) determines that the road surface is uphill. That is, if the front-wheel brake is actuated while traveling downhill, the vehicle body tends to drop on the front side. Therefore, the system reduces the predetermined threshold value so as to advance the timing of the switch to reduce the increase degree of the front-wheel brake fluid pressure or to maintain the brake fluid pressure at that time point. This enhances the driver's sense of security. While traveling uphill, the vehicle is less likely to drop on the front side upon actuation of the front-wheel brake. Therefore, the system delays the timing of the switch to reduce the increase degree of the front-wheel brake fluid pressure or to maintain the brake fluid pressure at that time point. This achieves high braking force.

### BRIEF DESCRIPTION OF DRAWINGS

FIG. 1 is a right side view of a motorcycle to which a brake system according to one embodiment of the present invention is applied.

FIG. 2 is a block diagram of the configuration of the brake system according to the present embodiment.

FIG. 3 is a graph of the transition of a pitch angular velocity and a front-wheel brake fluid pressure in automatic brake system control.

FIG. 4 is a graph of the transition of the pitch angular velocity and the front-wheel brake fluid pressure in the automatic brake system control.

FIG. 5 is a flowchart of the procedure of automatic brake control applied to the brake system according to the present embodiment.

FIG. 6 is a flowchart of the procedure of predetermined threshold value setting control.

### DETAILED DESCRIPTION

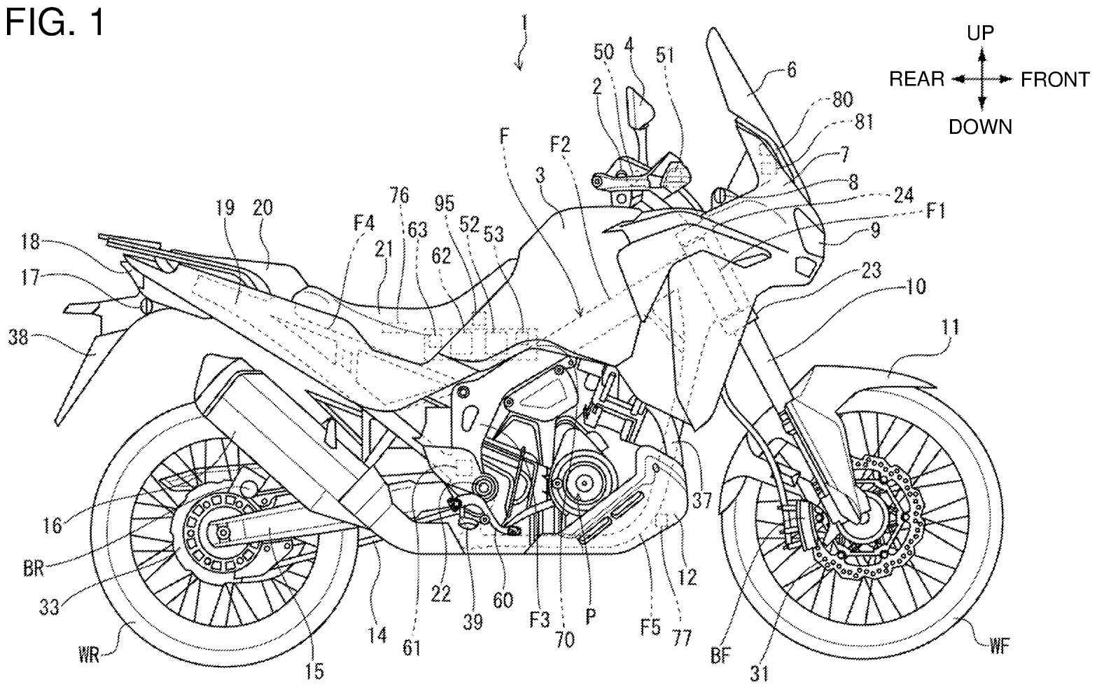

In the following, with reference to the drawings, a detailed description will be given of a preferred embodiment of the present invention. FIG. 1 is a right side view of a motorcycle 1 to which a brake system according to one embodiment of the present invention is applied. The motorcycle 1 is a saddled vehicle including a power unit P that transmits drive to a rear wheel WR via a drive chain 14. A head pipe F1 positioned at the front end of a vehicle body frame F swingably holds a not-shown steering stem. A bottom bridge 23 and a top bridge 24, fixed to the top and bottom of the steering stem, hold a pair of right and left front forks 10.

Steering handlebars 2 holding a pair of right and left rearview mirrors 4 are mounted on the top of the top bridge 24. A brake lever 50, i.e., a front-wheel brake operating element, is mounted on the right one of the steering handlebars 2. On the front forks 10, a front-wheel brake caliper BF, i.e., a front-wheel brake that applies braking force to a front-wheel brake disc 31 rotating in synchronization with a front wheel WF, and a front fender 11 are mounted.

A pair of right and left main frames F2 extending diagonally downward rearward and an underframe F5 extending downward are mounted on the rear of the head pipe F1. The underframe F5 holds the power unit P from below. The main frames F2 have their rear ends coupled to a pivot frame F3 including a pivot 22 swingably holding a swingarm 15. The pivot frame F3 has its lower end coupled to the rear end of the underframe F5. A pair of right and left foot steps 39 for receiving the driver's feet are mounted on the pivot frame F3.

Surrounded and held by the main frames F2 and the underframe F5, the power unit P transmits its drive to the rear wheel WR via the drive chain 14. An underguard 12 is mounted on the bottom frontward side of the power unit P. Through an exhaust pipe 37 extending inner than the underguard 12, the power unit P sends out exhaust gas to a muffler 16 on the vehicle's rear side.

The swingarm 15, pivotally held by the pivot 22, rotatably holds the rear wheel WR. The swingarm 15 holds a rear-wheel brake caliper BR, i.e., a rear-wheel brake that applies braking force to a rear-wheel brake disc 33 rotating in synchronization with the rear wheel WR. On the right side in the vehicle width direction, the pivot frame F3 swingably holds a brake pedal 50, i.e., a rear-wheel brake operating element for the driver to operate with his/her right foot.

A front cowl 7 is disposed in front of the head pipe F1. The front cowl 7 is equipped with a headlamp 9, a windshield screen 6, and a pair of right and left front flasher lamps 8. A fuel tank 3 is disposed behind the front cowl 7 and above the main frames F2. The pivot frame F3 has its rear part fixed to a rear frame F4 that supports a front seat 21 for the driver and a rear seat 20 for the passenger. Both lateral sides of the rear frame F4 are covered with a rear cowl 19. A rear fender 38 is mounted on the rear end of the rear cowl 19. The rear fender 38 is equipped with a tail lamp device 18 and a pair of right and left rear flasher lamps 17.

A control device 70 for controlling a fuel injection device, an ignition device, a brake system, and others is disposed above the vehicle body frame F. The control device 70 is integrated with a front-wheel brake actuator (hereinafter simply referred to as the actuator) 52 generating a brake fluid pressure for the front-wheel brake BF and a rear-wheel brake actuator 62 generating a brake fluid pressure for the rear-wheel brake BR. A front-wheel brake fluid pressure sensor 53 and a rear-wheel brake fluid pressure sensor 63 for detecting the brake fluid pressure of the front-wheel brake BF and that of the rear-wheel brake BR are disposed near the actuators 52, 62. A front-wheel brake operation force sensor 51 for detecting an operation force received at the brake lever 50 is disposed near the brake lever 50. A rear-wheel brake operation force sensor 61 for detecting an operation force received at the brake pedal 60 is disposed near the brake pedal 60.

A seat sensor 21 for detecting the seated state of the driver is disposed inside the front seat 21. The seat sensor 21 detects the state where the driver's load is applied as ON and the state where no load is applied as OFF. For example, the detected OFF state may include the case where the driver is lifting his/her body off the seat. On the side inner than the underguard 12, a road surface sensor 77 for sensing whether the road surface is wet is disposed.

A forward camera 80 and a forward radar 81 for use in automatic brake system control are disposed behind the windshield screen 6. The brake system according to the present embodiment is configured as follows. Normally, the actuators 52, 62 generate a brake fluid pressure corresponding to an operation force on the brake operating elements 50, 60. When an automatic control condition is met, such as the approach of an obstacle detected by the forward camera 80 and the forward radar 81, the control device 70 automatically generates an optimum brake fluid pressure even when there is no operation on the brake operating elements 50, 60. Under the automatic brake system control, the front/rear distribution, such as Front 7:Rear 3, or Front 6:Rear 4, is also automatically set according to vehicle speed, vehicle attitude, road surface condition, and the like.

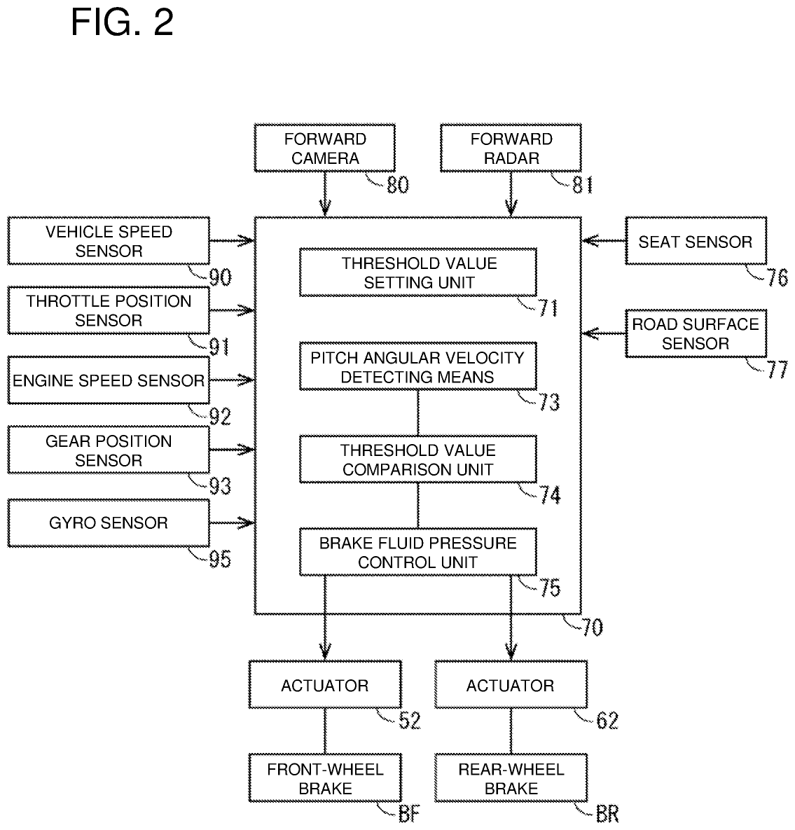

FIG. 2 is a block diagram of the configuration of the brake system according to the present embodiment. The control device 70 includes a threshold value setting unit 71, a timer 72, pitch angular velocity detecting means 73, a threshold value comparison unit 74, and a brake fluid pressure control unit 74. The control device 70 receives information from the forward camera 80, the forward radar 81, a vehicle speed sensor 90, a throttle position sensor 91, an engine speed sensor 92, a gear position sensor 93, and a gyro sensor 95, i.e., a pitch angular velocity detection unit. The control device 70 further receives information from the seat sensor 76 and the road surface sensor 77. The gyro sensor 95 detects the roll angular velocity, pitch angular velocity, and yaw angular velocity of the vehicle body. According to each angular velocity, the roll angle, the pitch angle, and the yaw angle can also be calculated.

The brake fluid pressure control unit 72 drives the actuators 52, 62 according to the information from various sensors so that the front-wheel brake BF and the rear-wheel brake BR exert a braking force. The pitch angular velocity detecting means 73 detects a pitch angular velocity co according to the output of the gyro sensor 95. The present embodiment is characterized in that, in the automatic brake system control, when the pitch angular velocity co becomes equal to or greater than a predetermined threshold value while the brake fluid pressure of the front-wheel brake BF is being increased, the system switches to reduce the degree of increase in the brake fluid pressure or to maintain the brake fluid pressure. According to the information from various sensors, the threshold value setting unit 71 sets the predetermined threshold value. The threshold value comparison unit 74 compares the predetermined threshold value and the pitch angular velocity co against each other to determine whether or not to switch to reduce the degree of increase in the brake fluid pressure or to maintain the brake fluid pressure.

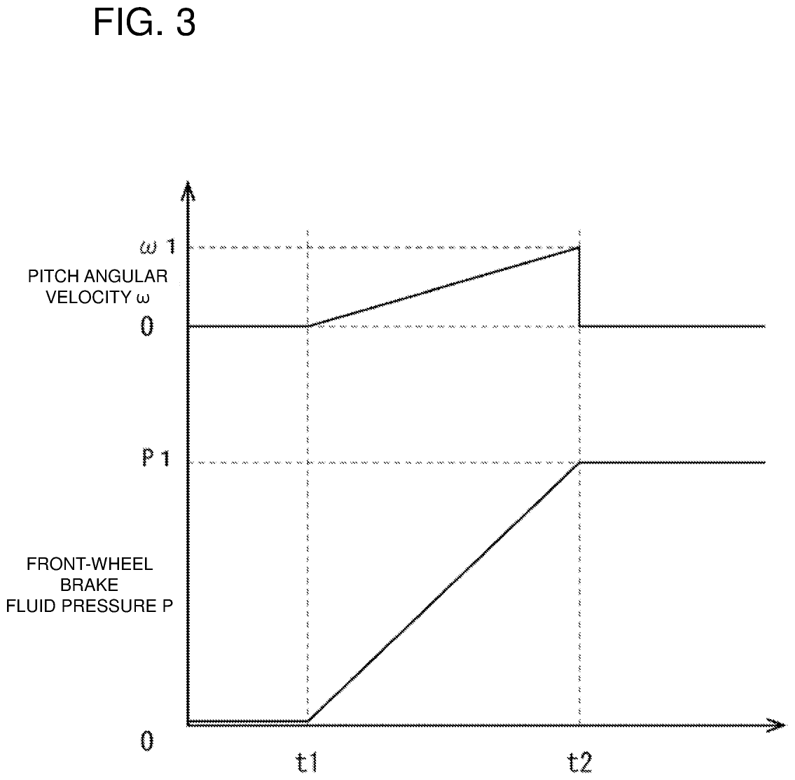

FIG. 3 is a graph of the transition of the pitch angular velocity co and the front-wheel brake fluid pressure P in the automatic brake system control. In the graph, the automatic control starts and the front-wheel brake fluid pressure P begins to increase at time t1, and the pitch angular velocity co reaches a predetermined threshold value wl at time t2. The present embodiment is characterized in that, when the pitch angular velocity co reaches a predetermined threshold value ω1 as the front-wheel brake fluid pressure P increases, the front-wheel brake fluid pressure P is maintained at a value P1 at that time point. This slows the speed at which the vehicle drops on the front side, giving the driver a sense of security. Note that, the front-wheel brake fluid pressure P may be increased linearly as in the drawing, or in a curved or stepwise manner.

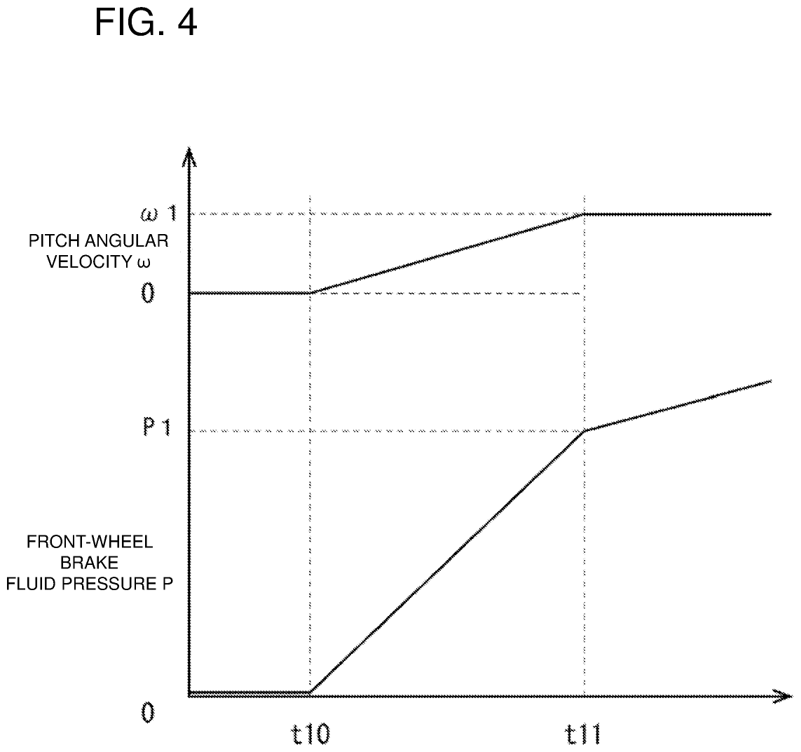

FIG. 4 is a graph of the transition of the pitch angular velocity co and the front-wheel brake fluid pressure P in the automatic brake system control. In the graph, the automatic control starts and the front-wheel brake fluid pressure P begins to increase at time t10, and the pitch angular velocity co reaches the predetermined threshold value ω1 at time t11. The present embodiment is characterized in that, when the pitch angular velocity co reaches the predetermined threshold value ω1 as the front-wheel brake fluid pressure P increases, the degree of increase in the front-wheel brake fluid pressure P is reduced (the slope of the graph is reduced). This slows the speed at which the vehicle drops on the right side, giving the driver a sense of security. Various changes may be made in the mode of reducing the increase degree.

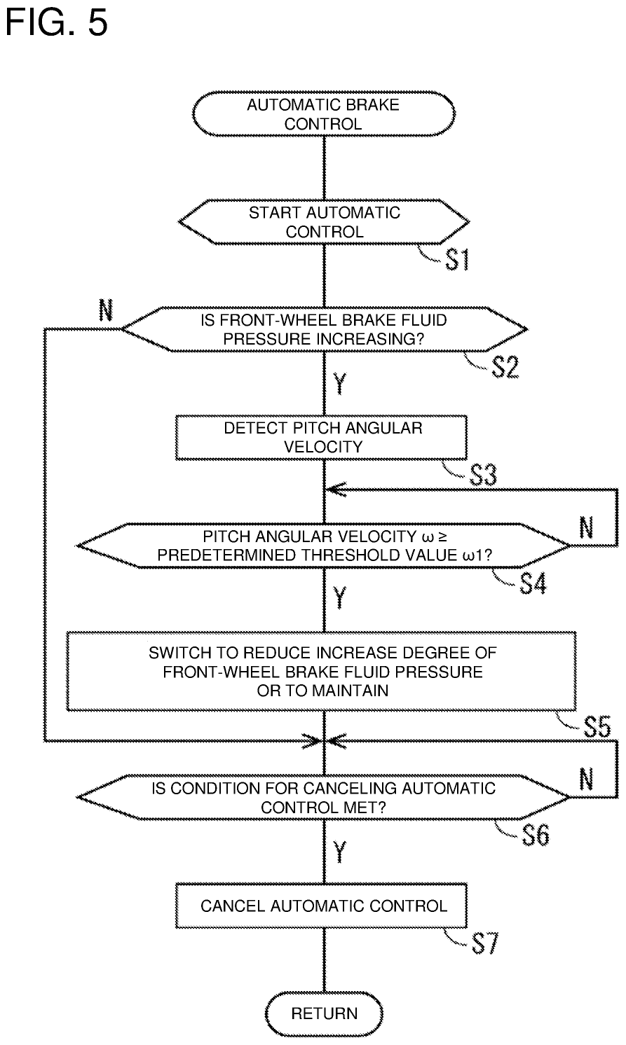

FIG. 5 is a flowchart of the procedure of automatic brake control applied to the brake system according to the present embodiment. In step S1, the automatic brake system control starts. The automatic control can be set to start in response to detecting the driver gripping the steering handlebars 2. In the next step S2, whether the front-wheel brake fluid pressure P is being increased is determined. When the determination is positive, control proceeds to step S3.

In step S3, the pitch angular velocity detecting means 73 detects the pitch angular velocity co. In the next step S4, whether the pitch angular velocity co is equal to or smaller than the predetermined threshold value ω1 is determined. When the determination in step S4 is positive, control proceeds to step S5 to switch the front-wheel brake fluid pressure P from being increased to being increased slower or maintained.

In step S6, whether a condition for canceling the automatic brake system control is met is determined. When the determination is positive, control proceeds to step S7. The automatic control canceling condition may include the following: the vehicle speed is equal to or lower than a predetermined value, the operation force on the brake operating element is equal to or greater than a predetermined value, the throttle operation volume and speed are equal to or greater than a predetermined value, and the vehicle roll angle is equal to or greater than a predetermined value. In step S7, the automatic control is canceled and switched to manual control, and the control procedure ends. Note that, when the determination is negative in step S2, control skips steps S3 to S5 and proceeds to step S6.

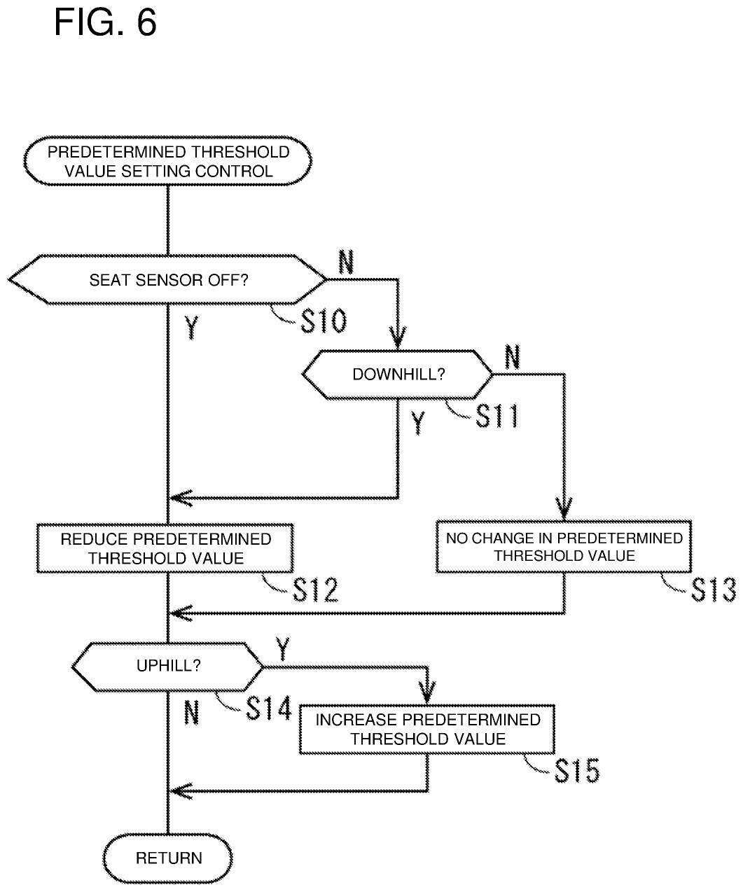

FIG. 6 is a flowchart of the procedure of predetermined threshold value setting control. In step S10, whether the output of the seat sensor 76 is OFF is determined. When the determination is positive, control proceeds to step S12 to reduce the predetermined threshold value. That is, if it is determined that the driver is standing based on the output of the seat sensor 76 being OFF, the system reduces the predetermined threshold value so as to advance the timing of the switch to reduce the increase degree of the front-wheel brake fluid pressure P or to maintain the brake fluid pressure at that time point. This enhances the driver's sense of security.

When the determination is negative in step S10, control proceeds to step S11 to determine whether the road surface is downhill. When the determination is positive in step S11, control proceeds to step S12 to reduce the predetermined threshold value That is, if the front-wheel brake BF is actuated while traveling downhill, the vehicle body tends to drop on the front side. Therefore, the system reduces the predetermined threshold value ω1 so as to advance the timing of the switch to reduce the increase degree of the front-wheel brake fluid pressure P or to maintain the brake fluid pressure at that time point. This enhances the driver's sense of security.

When the determination is negative in step S11, i.e., when it is not necessary to reduce the predetermined threshold value ω1, control proceeds to step S13 to maintain the predetermined threshold value ω1 and then proceeds to step S14. Note that, the degree of reducing the predetermined threshold value ω1 may be varied between several percent and several tens of percent, depending on the downhill gradient and the vehicle speed, for example.

In step S14, whether the road surface is uphill is determined. When the determination is positive, control proceeds to step S15 to increase the predetermined threshold value ω1. That is, while traveling uphill, the vehicle is less likely to drop on the front side upon actuation of the front-wheel brake BF. Therefore, the system delays the timing of the switch to reduce the increase degree of the front-wheel brake fluid pressure or to maintain the brake fluid pressure at that time point. This achieves high braking force. On the other hand, when the determination is negative in step S14, the control procedure ends as it is. Note that, the degree of increasing the predetermined threshold value ω1 may be varied between several percent and several tens of percent, depending on the uphill gradient.

Note that, the mode of the motorcycle, the configuration of the brake system, the mode of the front-wheel brake operating element and that of the rear-wheel brake operating element, the setting of the predetermined threshold value, the mode of the pitch angular velocity detection unit, and others, are not limited to those in the embodiment, and various changes may be made. For example, the brake fluid pressure may be switched from being increased to being reduced in response to the pitch angular velocity becoming equal to or greater than a predetermined threshold value. In the case where the pitch angular velocity is reduced due to the switch of the brake fluid pressure from being increased to being reduced, the brake fluid pressure can be increased again. In the case where the roll angle of the vehicle body is equal to or greater than a predetermined value while the roll angular velocity is equal to or greater than a predetermined threshold value, the braking device may reduce the threshold value if the estimated road friction coefficient value detected by a road surface state detection unit (e.g., the forward camera) is low. The brake system of the present invention is applicable not only to a motorcycle but also to a saddled three- or four-wheeled vehicle and others.

### REFERENCE SIGNS LIST

1: motorcycle (saddled vehicle)
52: front-wheel brake actuator
62: rear-wheel brake actuator
70: control device
71: threshold value setting unit
72: timer
73: pitch angular velocity detecting means
74: threshold value comparison unit
75: brake fluid pressure control unit
76: seat sensor
77: road surface sensor
80: forward camera
81: forward radar
95: gyro sensor (pitch angular velocity detection unit)
BF: front-wheel brake
BR: rear-wheel brake

1. A brake system for a saddled vehicle, comprising:
a control device exerting automatic control over a brake fluid pressure of a brake according to various information; and
a pitch angular velocity detector configured to detect a pitch angular velocity of the vehicle according to an output of a pitch angular velocity detection unit,
wherein when the pitch angular velocity becomes equal to or greater than a predetermined threshold value while the control device is gradually increasing the brake fluid pressure of a front-wheel brake by the automatic control, the control device reduces a degree of increase in the brake fluid pressure or maintains the brake fluid pressure at that time point.

2. The brake system for a saddled vehicle according to claim 1, further comprising a seat sensor detecting a driver's seated state, wherein the control device reduces the predetermined threshold value when the seat sensor does not detect the driver's seated state.

3. The brake system for a saddled vehicle according to claim 1, wherein the control device reduces the predetermined threshold value when the control device determines that a road surface on which the vehicle is traveling is downhill, and increases the predetermined threshold value when control device determines that the road surface is uphill.
